(19) United States
(12) Patent Application Publication
(10) Pub. No.: US 2017/0278135 A1
(43) Pub. Date: Sep. 28, 2017

(54) IMAGE RECOGNITION ARTIFICIAL INTELLIGENCE SYSTEM FOR ECOMMERCE

(71) Applicants: Manindra Majumdar, Berkeley, CA (US); Shanglin Yang, El Cerrito, CA (US); Sudharshan Sakthivel, Berkeley, CA (US); Fitroom, Inc., Berkeley, CA (US)

(72) Inventors: Manindra Majumdar, Berkeley, CA (US); Shanglin Yang, El Cerrito, CA (US); Sudharshan Sakthivel, Berkeley, CA (US)

(73) Assignee: Fitroom, Inc., Berkeley, CA (US)

(21) Appl. No.: 15/438,518

(22) Filed: Feb. 21, 2017

Related U.S. Application Data
(60) Provisional application No. 62/354,282, filed on Jun. 24, 2016.
(60) Provisional application No. 62/297,020, filed on Feb. 18, 2016.

(51) Int. Cl. G06Q 30/02; G06T 7/00; G06F 17/30

(52) U.S. Cl. CPC G06Q 30/0256; G06F 17/30247; G06F 17/3028; G06T 7/0002; G06F 17/30265; G06F 17/30047; G05B 2219/49023

(57) ABSTRACT

A method for a user to select merchandise online for purchase, by: (a) the user uploading an image to a computer system in a search query; (b) the computer system using image recognition software to find images similar to the uploaded image in the search query; (c) the computer system displaying to the user the images that are similar to the uploaded image, wherein the display of images is presented to the user as a webpage, and wherein the webpage address is saved as a unique URL; (d) the user selecting one of the displayed images, thereby selecting an article of merchandise corresponding thereto; and (e) the user purchasing the article of merchandise.

### RELATED APPLICATIONS

The present application claims priority from U.S. Provisional Patent Applications 62/354,282, entitled “Image Recognition Artificial Intelligence System For Ecommerce”, filed Jun. 24, 2016 and 62/297,020 entitled “Image Recognition and 3D Printing System”, filed Feb. 18, 2016, the full disclosures of which are incorporated herein by reference in their entireties for all purposes.

### TECHNICAL FIELD

The present invention also relates to image recognitions systems for: (a) performing searches of images and sharing searches on social media to monetize search results; (b) training neural networks to identify objects; and (c) selecting and purchasing merchandise online.

### SUMMARY

In a first aspect, the present invention provides a system for monetizing search results on the basis of uniquely generated and saved URLs. Specifically, the present system comprises a preferred method for a user to monetize image searches for an article of merchandise, comprising: (a) the user uploading an image to a computer system in a search query; (b) the computer system using image recognition software to find images similar to the uploaded image in the search query; (c) the computer system displaying to the user the images that are similar to the uploaded image, wherein the display of images is presented to the user as a webpage having a unique URL; (d) the user saving the unique URL; (e) the user sharing the unique URL on social media; (f) the user being paid when a second user: (i) views the unique URL, (ii) likes the unique URL, (iii) shares the unique URL, or (iv) purchases the article of merchandise through the unique URL. Preferably, the user is paid by the business entity controlling the computer system, and the amount paid to the user is calculated as a percentage of the purchase made by the second user to a seller of the article of merchandise.

An advantage of this aspect of the invention is that the present approach creates, saves and shares unique URLs for its searches. Systems currently exist for performing online merchandise searching. However, with the present addition of unique search URLs added to the searches, different people are able to perform (and update) different search results, with these different users sharing their own search results with others. As a result, other users of the system may learn to trust or follow the searches of searchers they are following. This provides a system in which users can best find the goods they are looking for online by trusting the searches performed by persons having similar tastes.

In other preferred aspects, the search results are based on preferences from other users in an affinity group that includes the user. Membership in the affinity group can be based on similarities in preferences of purchasing the article of merchandise. For example, the preferences of purchasing the article of merchandise can include similarities in: (i) amount spent to purchase the article of merchandise, (ii) the frequency of purchasing the article of merchandise, or (iii) the identity of the seller of the article of merchandise.

The advantage of using an affinity group is that affinity groups assist in optimizing search results. Specifically, the search results given to one user can be based on similar search results given to persons who make similar purchases and have similar tastes.

In preferred aspects, the image uploaded by the user is an image from a video, with the user tagging the image from the video with keywords. In optional aspects of the present system, the search results can be displayed as 2D images, 3D images, or images in virtual reality (e.g. displayed over imaginary or remote backgrounds) or augmented reality (displayed over a background image as currently viewed by a smartphone camera). In further optional aspects of the invention, additional search results are determined and displayed for the user as the user scrolls down the webpage.

In other preferred aspects, the image search can be iterative with the results of the search generating results that are fed into the next search. Such an iterative search can be performed by: (1) the user viewing the displayed images, (2) the user selecting one of the displayed images as a preferred image, (3) the computer system iteratively updating the search query using image recognition software to find images similar to the preferred image, and (4) the computer system displaying to the user the images that are similar to the preferred image. Steps (1) to (4) can be repeated any number of times, and the computer system can display the preferred image together with the images that are similar to the preferred image at each iteration of the search.

Advantages of the iterative searches can include searches that are maintained continually up to date (with the most recent articles of merchandise being identified by one user for the benefit of other users).

In a second aspect, the present invention provides a system for selecting 3D articles either for a user to print, or to have others print for the user. Specifically, the present system includes a method for a user to select an article of merchandise online for 3D printing, comprising: (a) the user uploading an image to a computer system in a search query; (b) the computer system using image recognition software to find images similar to the uploaded image in the search query; (c) the computer system displaying to the user the images that are similar to the uploaded image; (d) the user selecting one of the displayed images, thereby selecting an article of merchandise corresponding thereto; and (e) the user purchasing the article of merchandise for 3D printing by: (i) downloading a 3D print model of the article of merchandise and then 3D printing the article of merchandise, or (ii) purchasing the article of merchandise from a vendor that 3D prints the article of merchandise. The determination as to whether to purchase the 3D article of merchandise from the vendor can include selecting the vendor on the basis of: (i) proximity to the user, or (ii) price. The computer system may make this decision automatically, or the computer system may instead display a list of vendors, and the user can then select the vendor.

An advantage of this system is that it uses an image recognition search engine, as opposed to only a keyword-based search engine when selecting the 3D images. Another advantage of this method is that search results can be quickly updated, as needed. In optional aspects of the invention, non-3D (i.e.: 2D) images are instead searched, preferably to find articles of merchandise corresponding thereto. Additionally, image recognition systems using neural networks and machine learning can be trained to identify 3D objects based on 2D images taken at different angles or through neural networks that assist in classifying the 3D objects.

### BRIEF DESCRIPTION OF THE DRAWINGS

FIG. 1 is a schematic illustration of a preferred method of selecting 3D articles to print or to have others print.

FIGS. 2A to 2C are illustrations of sequential computer screen displays corresponding to the preferred method seen in FIG. 1.

FIGS. 3A to 3C are schematic illustrations of a preferred method of monetizing search results by generating and sharing unique URLs of the searches.

FIG. 4 is a schematic illustration of a preferred method of image cropping by hovering over the image prior to uploading the image.

FIGS. 5A to 5C are illustrations of sequential computer screen displays corresponding to the preferred method seen in FIG. 4.

FIG. 5D is an example corresponding to FIG. 5B showing a webpage operating the present system as viewed on a computer monitor and on a smartphone.

FIG. 6 is an illustration of a preferred method of isolating images from a video for uploading the images into the present computer system's image recognition search engine.

FIG. 7 is a schematic illustration of a preferred method of basing search results on affinity (i.e.: consumer behavior) groups that have similar purchasing preferences to one another.

FIG. 8 is an illustration of two users in the same affinity group.

FIG. 9 is a schematic illustration of a preferred method of performing an iterative image search.

FIGS. 10A and 10B are illustrations of sequential computer screen displays corresponding to the preferred method seen in FIG. 9.

FIG. 11 is a 3D Object Identifier system for use in accordance with the present invention.

FIG. 12 is an exemplary nested neural network system for use in accordance with the present invention.

FIG. 13 is an illustration of a hybrid method for searching for images using both an image search engine and natural language processing.

FIG. 14 is an illustration of a method of speech analysis to generate image search results.

FIG. 15 is an illustration of a method of performing image searches in conjunction with an influencer doing a video or livestream presentation.

FIG. 16 is an illustration of the training of an intelligent vision labelling system that comprises a neural network that uses machine learning.

FIG. 17 is an illustration of the training an intelligent vision labelling system that comprises a neural network that uses natural language processing.

FIG. 18 is an illustration of an intelligent pattern matching system that comprises a neural network.

FIG. 19 is an illustration of a Dynamic Approximate Nearest Neighbor Data Structure.

FIG. 20 is an illustration of a Triplet Structure for image training a neural network.

### DETAILED DESCRIPTION OF THE DRAWINGS

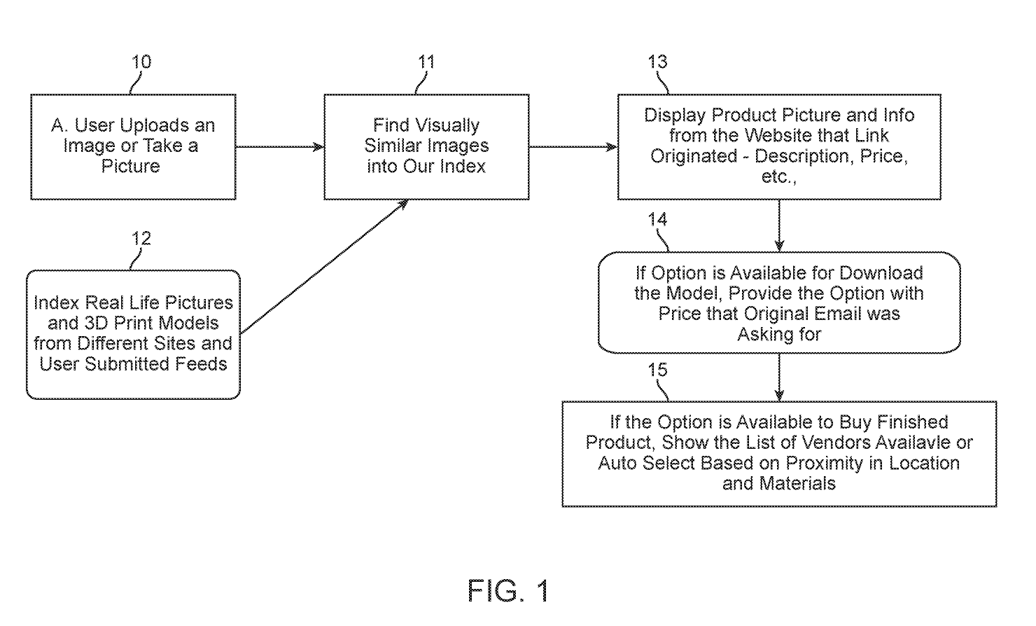

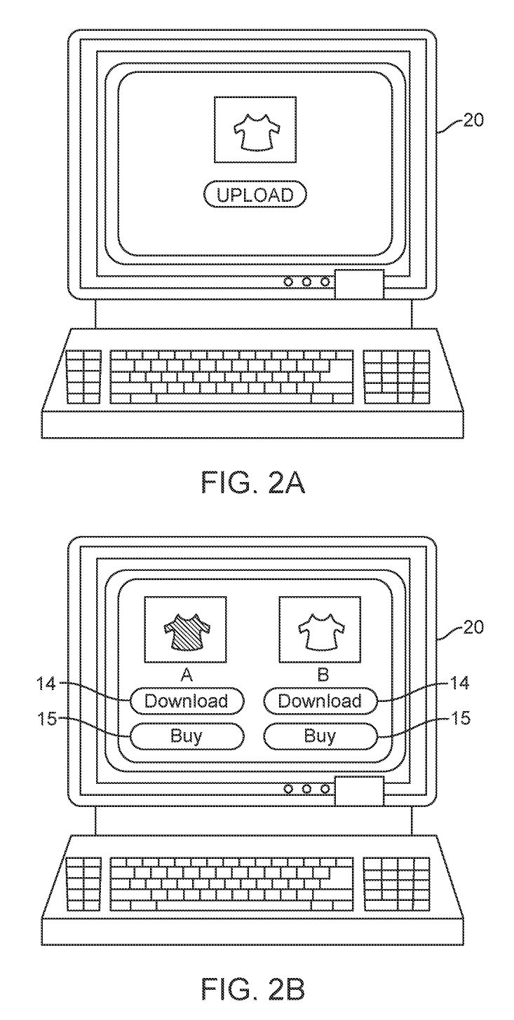

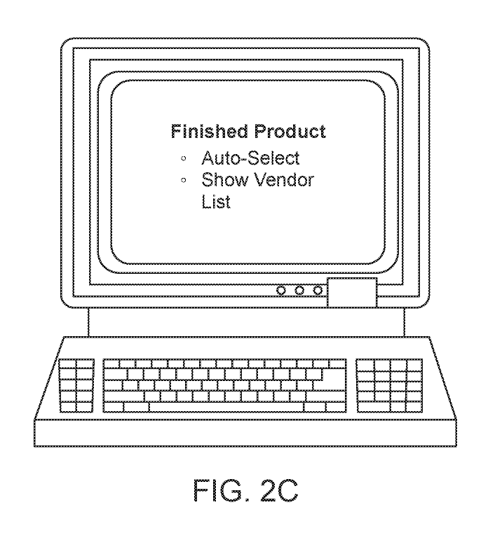

FIGS. 1 and 2 illustrate a preferred method of selecting 3D articles to print or to have others print, as follows.

First, the user uploads an image to a computer system in a search query (step 10, as seen by a user in computer screen 20 in FIG. 2A). Next, the computer system uses image recognition software to find images similar to the uploaded image in the search query (step 11). This can be done by comparing the uploaded image to an index of stored pictures and/or 3D print models taken from different websites and optionally also from different user feeds (step 12). Next, the computer system displays to the user the images that are similar to the uploaded image (step 13 and computer screen 20 in FIG. 2B). The user then views the images and may select image “A” as a more desirable product than image “B”. (Note, only two images “A” and “B” are shown here for ease of illustration. In practice, many more images may be displayed to best cater to the tastes of different individuals.) After the user has selected image “A”, the computer system then proceeds either to step 14 where the user is given the option to purchase the article of merchandise for 3D printing by downloading a 3D print model of the article of merchandise and then 3D printing the article of merchandise, or to step 15 where the user is given the option to purchase the article of merchandise from a vendor that 3D prints the article of merchandise.

Next, as seen in FIG. 2C, the vendor may optionally be selected on the basis of: (i) proximity to the user, or (ii) price. This selection may be done automatically by the computer (based on variables pre-programmed by the user or by the administrator or owner of the computer system). Alternatively, this vendor selection can be done by the user with the computer system displaying a list of vendors, such that the user can select their preferred vendor.

Optionally, the present system automatically generates additional images as the user scrolls down the page. Thus, if the user does not initially see a desirable image, the present system automatically continues to search for new images and display them for the user until such time that the user sees a desirable image and stops searching.

In other optional aspects of the invention further discussed below, the images that are displayed to the user have been previously rated or rearranged by the input of another user.

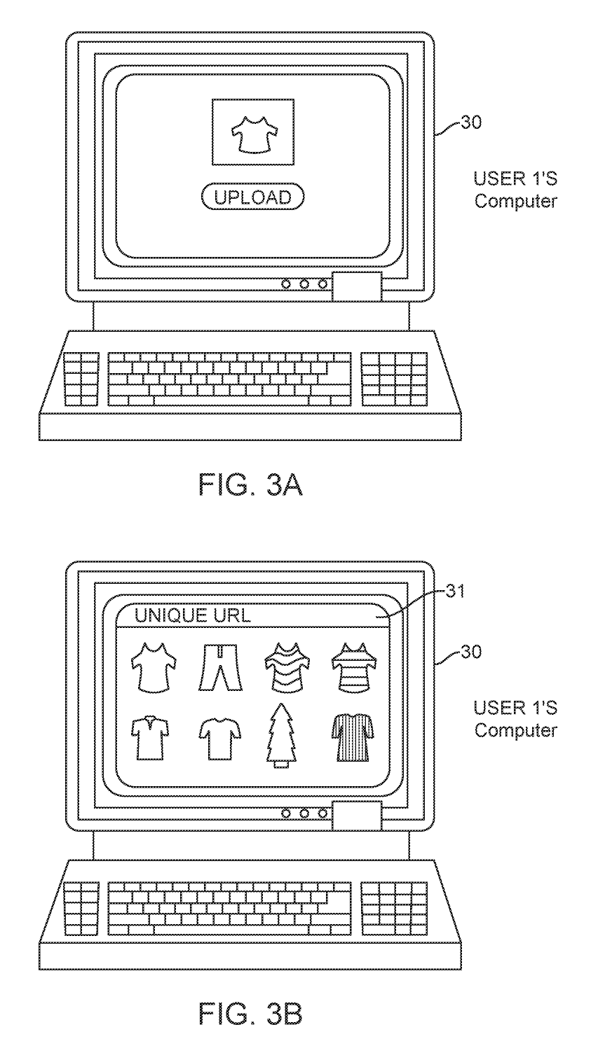

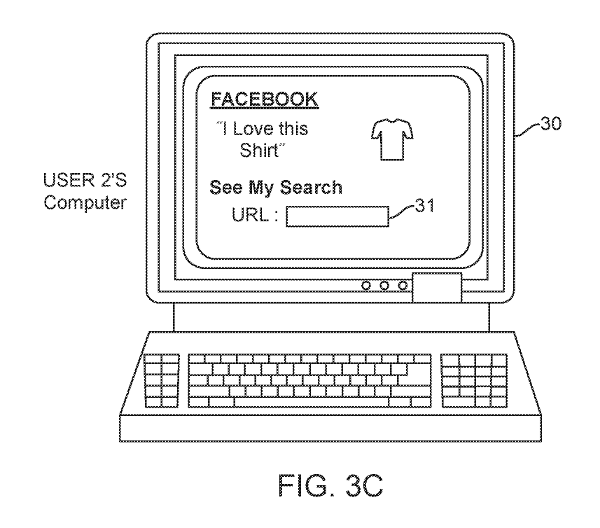

FIG. 3 illustrates a preferred method of monetizing search results by generating and sharing unique URLs of the searches, in those optional aspects of the present system where the display of images is presented to the user as a webpage, and wherein the webpage address can be saved and/or shared by the user as a unique URL, as follows.

First, in FIG. 3A, on display screen 30, the user (user 1) uploads an image to a computer system into a search query. Next, in FIG. 3B, the present computer system uses image recognition software to find images similar to the uploaded image in the search query. The search results are displayed for user 1 on screen 30. Importantly, the search results are displayed as a webpage having a unique URL 31. As such, a unique URL is created for user 1's search. User 1 can then save this unique URL 31.

Next, as seen in FIG. 3C, user 1 can monetize their search results by sharing unique URL 31 on social media. User 2 can then view User 1's unique URL 31. User 2 may then simply view user 1's search results. Or, user 2 may “like” or “share” the unique URL of user 1's search results. As well, user 2 may simply see something they would like to purchase directly from the user 1's search results. User 1 can then be paid a portion of the sale price of the item. As such, user 1 can be financially compensated for purchases that user 2 makes using user 1's search results. It is to be understood that this referral monetization system can be made for any article of merchandise, (including 3D printed articles and non-3D printed articles). Moreover, this referral monetization system can be made for any service purchased by user 2 (based on the searches saved and shared by user 1).

In one preferred application, the owner or administrator of the present system can be the entity paying user 1 for his/her search results that result in sales made to user 2. The owner or administrator of the present system can be paid by the seller of the article or service based upon a percentage of the sale value. Thus, the owner or administrator of the present system is rewarded for operating a computer system that refers purchases to the seller, and user 1 is also rewarded for performing search results that refers purchases to the seller. Optionally, user 1 can be paid only if user 2 makes a purchase. The amount paid may simply correspond to a percentage of the purchase (e.g.: 1%). However, user 1 could also be paid (a smaller amount) if user 2 likes, shares or simply views user 1's search results.

It is to be understood that User 1 (as described herein) may be an individual or a company or any other entity including one or more than one person. In such cases, the use may be a group of employees working for the same marketing branch of a company who are specifically employed to generate and share unique search result URL's on social media (as a way to promote the company itself or to generate sales).

In some optional preferred aspects, the articles of merchandise that user 1's search causes user 2 to purchase can be 3D printed articles. User 2 can then purchase the 3D printed articles of merchandise by: (i) downloading a 3D print model of the article of merchandise and 3D printing the article of merchandise, or (ii) purchasing the article of merchandise from a vendor that 3D prints the article of merchandise, as was previously explained.

In other optional aspects, user 2 may take the search results from user 1, and perform additional searches on these results. These new or revised searches performed by user 2 can also be saved as other unique URLs which can also be shared with additional system users. As a result, a search performed by user 2 can be used to facilitate a purchase made by user 3 (not shown). In accordance with the present system, user 2 can then be fiscally compensated by the purchases made by user 3.

Optionally, user 1 may add ratings to the displayed images on the webpage, with the computer system then incorporating the added ratings into the unique URL for the webpage, prior to user 1 saving and sharing the unique search results URL.

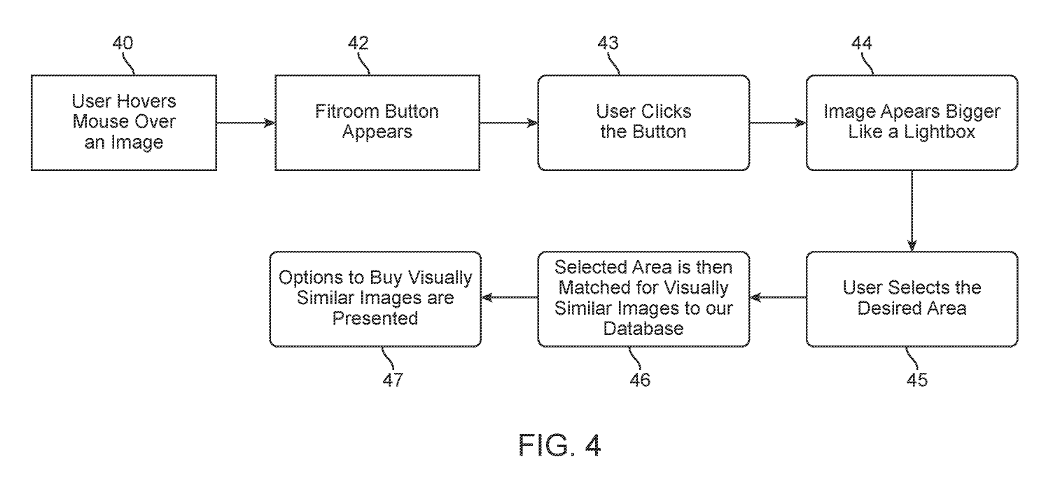

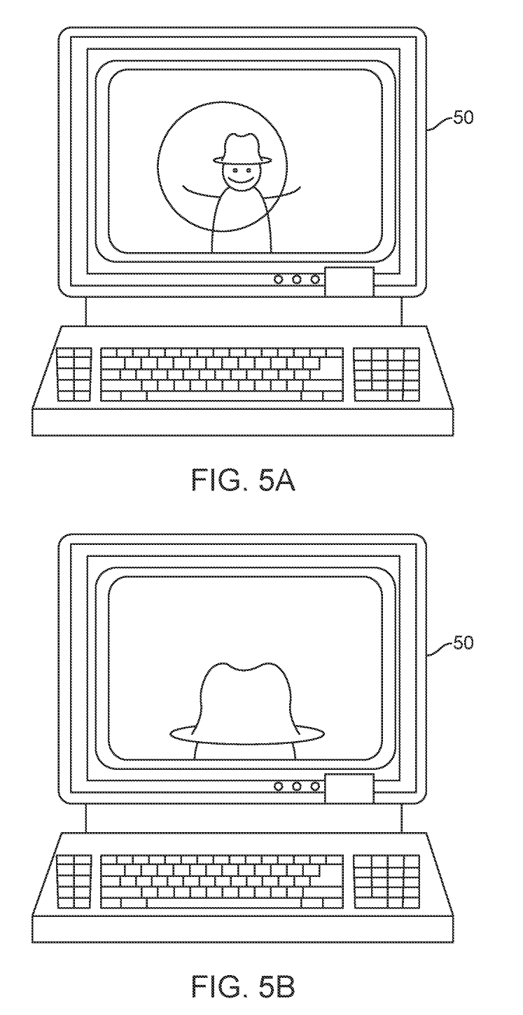

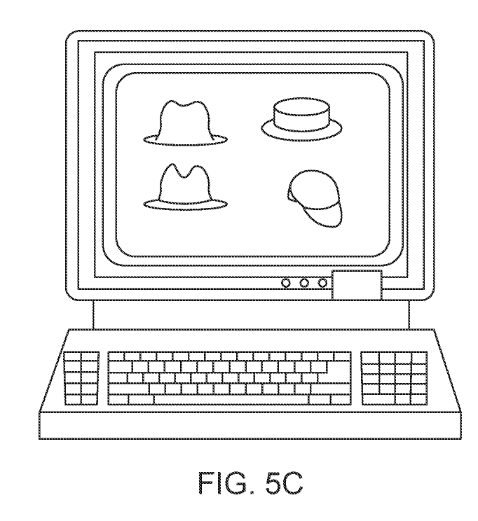

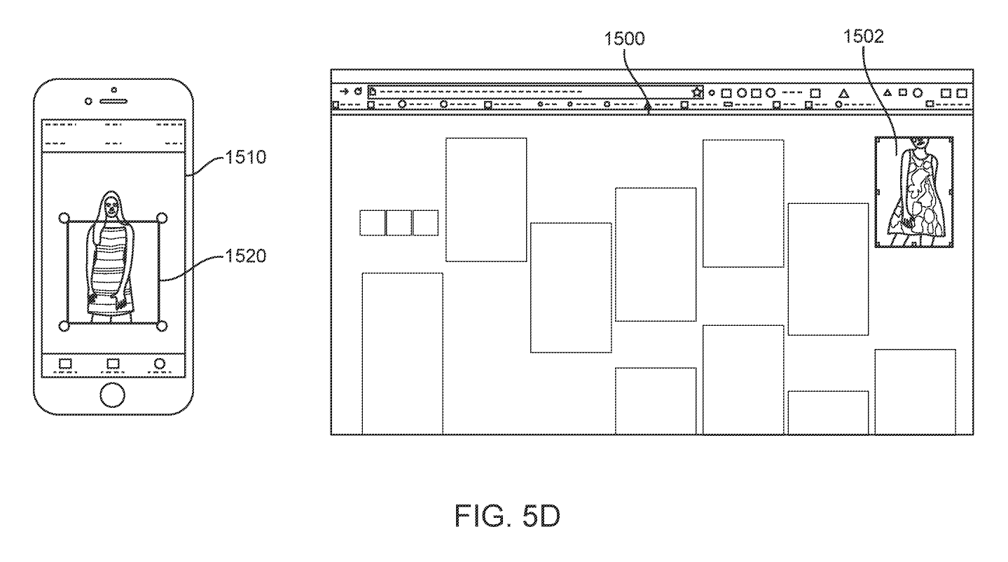

FIGS. 4 and 5 illustrate a preferred method of image cropping by hovering over the image prior to uploading the image, as follows. Such image cropping is used to assist the image recognition focus best on the selected image (and narrow the image processing analysis away from other nearby objects).

First, at step 40 in FIG. 4, the user hovers a cursor at an image on a webpage. Next, at step 42, a “button” appears on screen (as seen on computer screen 50 in FIG. 5A). Next, at step 43, the user clicks the button. Next, at step 44, the image appears bigger (like in a lightbox). The user then selects the desired area to crop at step 45 (as seen on computer screen 50 in FIG. 5B). Next, the user uploads the enlarged and cropped image to the computer system (as described above) and the present computer system then uses image recognition software to select visually similar images at step 46, with these visually similar options to purchase displayed at step 47 (and as seen on computer screen 50 in FIG. 5C).

In preferred aspects, the computer system uses image recognition software to find images similar to the uploaded image in the search query by: (i) generating keywords corresponding to the uploaded image; and (ii) comparing the keywords corresponding to the uploaded image to keywords corresponding to other articles of merchandise stored in an index. In other embodiments, the user enters the keywords into the search query. In further optional embodiments, the user speaks and says the name of the object and the system analyzes the spoken words and translates them into machine readable text such that the spoken words can be used as further search keywords.

FIG. 5D is an illustration of a webpage operating the present system as viewed on a computer monitor and on a smartphone. A user views computer webpage 1500 and then crops an image 1502 to be input into the present system's image recognition system. Similarly, for a smartphone, the user views webpage 1510 and then crops an image 1520 to be input into the present system's image recognition system.

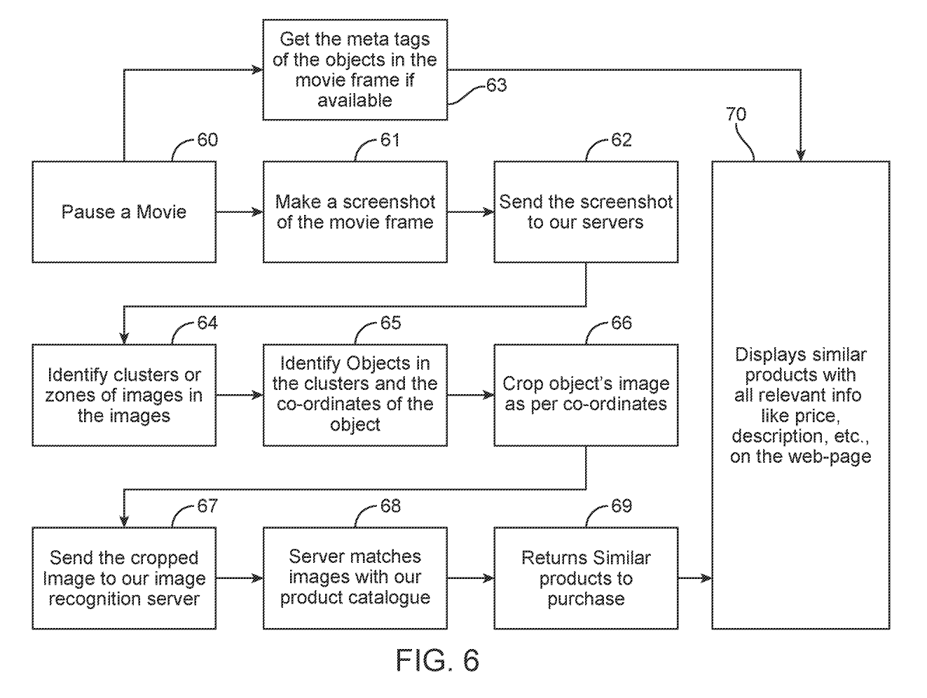

FIG. 6 is an illustration of a preferred method of isolating images from a video for uploading the images into the present computer system's image recognition search engine, as follows.

First, at step 60, the user pauses a movie. (S)he can then make a screenshot at 61 and then send the screenshot to the administrator of the present computer system at 62. Alternatively, the user may simply get meta tags of the objects in the movie frame from if they are available at step 63 (and thus proceed directly to step 70). At step 64, the user can identify clusters or zones of images in the movie frame. At step 65, the user can identify the objects in the clusters and the coordinates of the objects. At step 66, the image can then be cropped (for example, by its coordinates). At step 67, the cropped image can be uploaded to the present image recognition software server. The present computer system can then match the uploaded image to images in its catalogue at 68, and identify similar images at 69. Next, at step 70, the similar images can be displayed to the user in his/her resulting search results. (Should the user instead get meta tags at optional step 63, then the computer system can display the results at step 70 directly).

In preferred aspects, the owner or administrator of the present computer system will perform its own search for any meta data on the video. This can be done by capturing the source page of the video and the time when the video is paused.

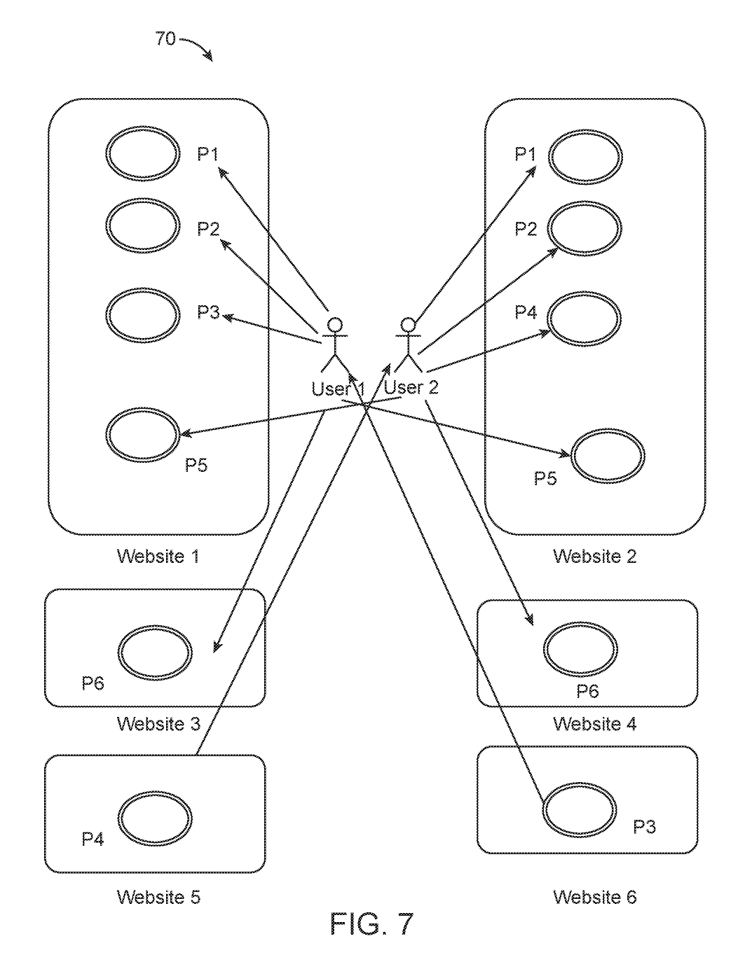

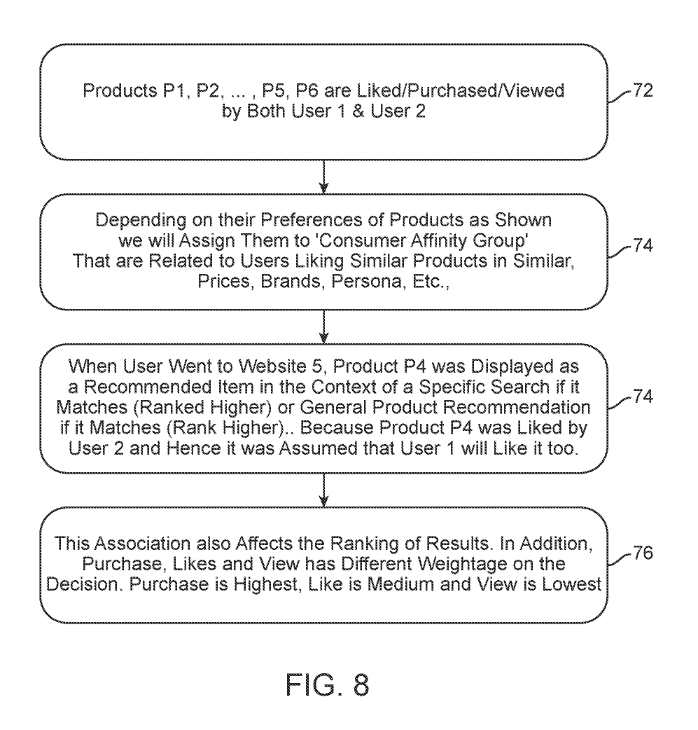

FIGS. 7 and 8 show schematic illustrations of a preferred method of basing search results on affinity (i.e.: consumer behavior) groups that have similar purchasing preferences to one another, as follows.

As seen in FIG. 7, at 70 user 1 visits websites 1, 3, and 5, and purchases products P1, P2, P3, P5 and P6. Similarly, user 2 visits websites 2, 4, and 6 and purchases products P1, P2, P4, P5, P6 and P7.

Next, as seen in FIG. 8 an affinity group can be set up, as follows. First, at step 72, it is determined that users 1 and 2 both purchased (or liked) products P1, P2 and P5. Therefore, at step 74, users 1 and 2 can be placed in a similar “consumer affinity group” based on similarities in preferences of purchasing the article of merchandise. Specifically, the search results given to one user can be based on preferences from other users in the same affinity group that includes the user. For example, product P4 can be displayed as a recommended article for user 1 since user 2 liked or purchased product P4. At step 76, the association into consumer behavior affinity groups can optionally affect the ranking of search results. As generally understood herein, the preferences of users in an affinity group purchasing articles of merchandise or services can comprise similarities in: (i) amount spent to purchase the article of merchandise, (ii) frequency of purchase of the article of merchandise, or (iii) identity of the seller of the article of merchandise. Other factors may optionally be taken into account as well when setting up consumer affinity groups. Different users may be members of different affinity groups for the purchase of different articles of merchandise or different services. For example, users 1 and 2 may be determined to have similar tastes when purchasing furniture, but very different tastes when purchasing clothes. As such, uses 1 and 2 could be grouped in the same affinity group for “furniture” with their individual search results tending to select, highlight (or otherwise display more predominantly) search results that are well received (i.e.: viewed or purchased) by others in the same affinity group.

In different aspects of the present system, the search results that are sent to each user can be sorted and prioritized when displayed to the user on the basis of the preferences of other members of their affinity group(s). Moreover, the preferences of other members of the affinity group purchasing the article of merchandise comprise similarities in: (i) articles of merchandise being viewed, (ii) the articles of merchandise being liked, (iii) the articles of merchandise being shared on social media, or (iv) the articles of merchandise being purchased.

Optionally, the search results can be prioritized higher when other members of the affinity group purchase the article of merchandise than when the other members of the affinity group share or like the article of merchandise on social media. Optionally as well, the search results can be prioritized higher when other members of the affinity group share or like the article of merchandise on social media than when the other members of the affinity group view the article of merchandise. Preferably, the search results can be continuously or regularly updated based upon continuous or regular updates of the preferences of other members of the affinity group.

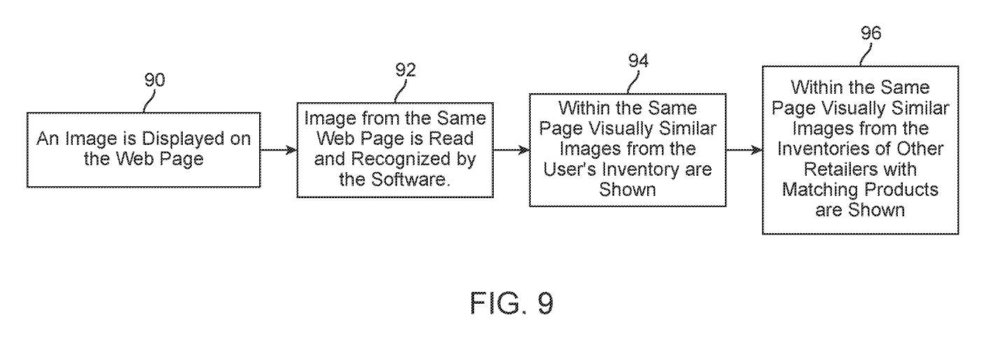

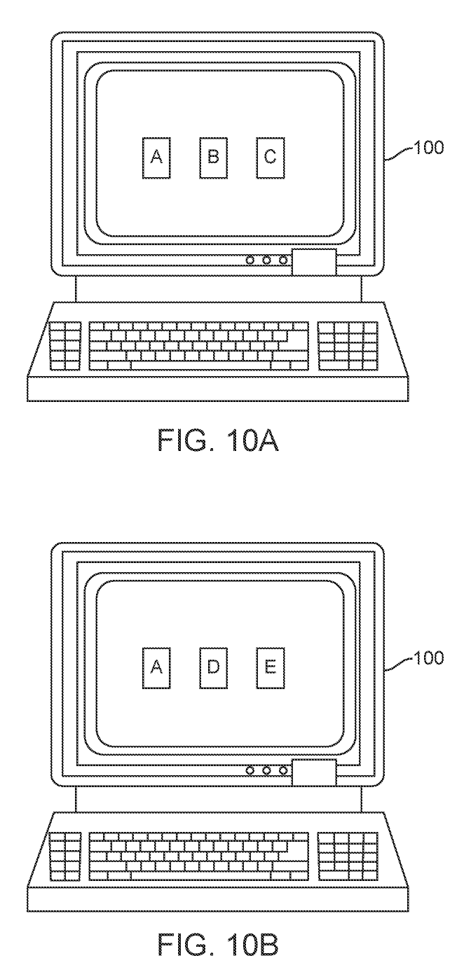

FIGS. 9 to 10B illustrate a preferred method of performing an iterative image search for use in accordance with various aspects of the present system. At step 90, the computer system displays search results as seen on screen 100 in FIG. 10A. Specifically, the computer system has identified three products A, B and C. At step 92, the user then selects item “A” as their most preferred item. At this time, item “A” is then searched by the computer system at step 94 to find similar images (in this case, items “D” and “E”) as display on screen 100 in FIG. 10B at step 96. This process can be repeated with the user selecting their preferred image, and the image recognition search being performed on this newly-selected image. As one iteration is performed after another, the user is able to “fine-tune” their search. The user may only update the search once (one iteration), or (s)he may perform multiple iterations as desired. Eventually, the user may use this iterative search process to best select the item they wish to purchase, or to generate a new unique URL of the most up-to-date search iteration which can be shared on social media (to monetize the user for performing the search).

Preferably, as the user scrolls down through images, additional images will be automatically generated such that the user is able to scroll down until they view an image to their liking.

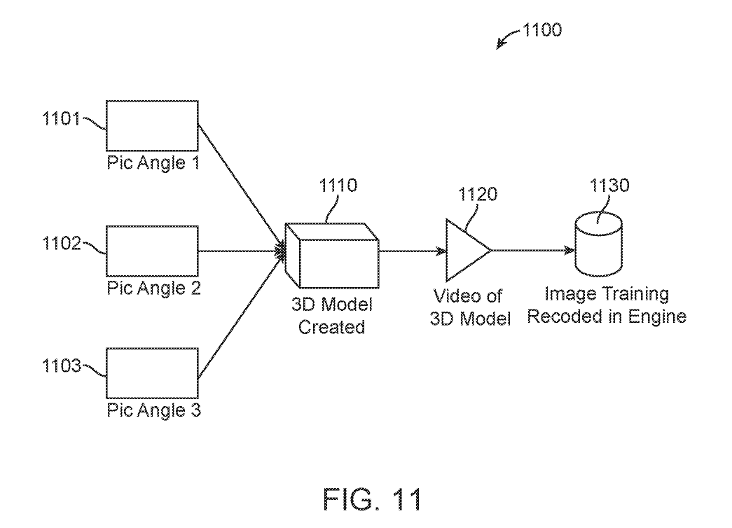

FIG. 11 illustrates an optional 3D Object Identifier system 1100 for use with the present invention's image search engine. Physical objects (i.e. objects in real life) are first photographed from various angles. For example, three pictures 1101, 1102 and 1103 are taken of an object. (For example, photos of the front, back and side of a chair). From these various photos, a 3D model of the object is created at 1110. From 3D module 1100, a 3D video 1120 is then created. This 3D video 1120 is then input into search engine 1130. Machine learning is used such that 3D videos of a large number of objects can be input into search engine 1130. Over time, search engine 1130 is thus trained to recognize various 3D objects. Picture angles are optionally connected to tags such that the system is able to understand various products (i.e.: physical objects) from different angles. One advantage of system 1100 is that each level of the system can operate separately (with further pictures being added and models created) even though the final file may still be under processing. Moreover, if a new type of product enters the marketplace, the present system can learn to recognize it (and add this new product category to the database). Moreover, the present system 1100 may preferably be operated to recognize images based on receiving 2D images, 2D videos or 3D videos of the object. For example, the present system could quickly determine if an image of an object was an image of a chair based upon other images of the chair taken at different angles and inputted into the present system.

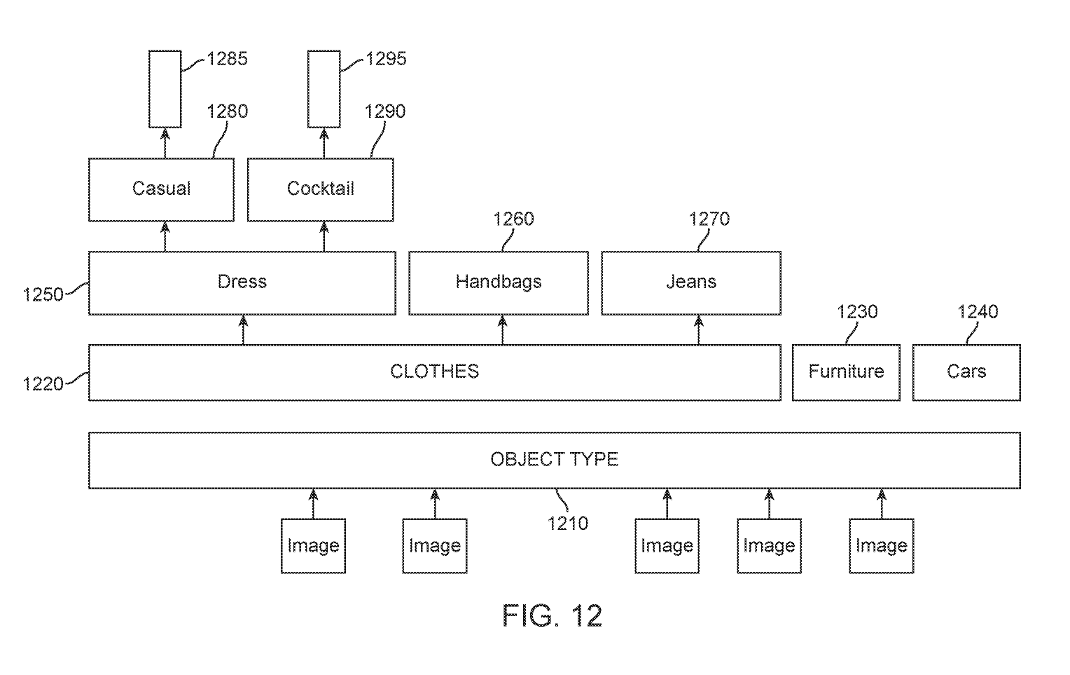

FIG. 12 is an exemplary neural network 1200 that can be used to classify images for image recognition in the present search engine. Traditionally, neural networks examine a body of knowledge that is both “deep” and “narrow”. For example, traditional neural networks have been used to point out small differences between objects or systems that are quite similar to one another. These traditional neural networks do not know how to handle objects or systems that are outside their narrow realm of recognition. It is also difficult to add, change or delete previous learnings in a traditional neural network.

In accordance with an optional aspect of the present invention, a “modular” neural network 1200 is provided. Neural network 1200 is composed of separately functioning neural networks that are organized into levels of neural networks. For example, an image of an object (i.e.: an image selected by a user to input into their image search) will first be received into the system at 1210. Next, three separate neural networks 1220, 1230 and 1240 will then examine the image. Each neural network will try to answer one classification question. Neural network 1220 will simply ask: “Is this an image of clothing?” Neural network 1230 will ask: “Is this an image of furniture?” Neural network 1240 will ask: “Is this an image of a car?” Should neural network 1220 determine that the image is indeed an image of “clothing”, the image will then be passed to three more neural networks (1250, 1260 and 1270). Neural network 1250 will ask: “Is this an image of a dress?” Neural network 1260 will ask: “Is this an image of a handbag?” Neural network 1270 will ask: “Is this an image of a pair of jeans?” Should neural network 1250 determine that the image is one of a dress, the image will then be passed to two other neural networks. Neural network 1290 will ask: “Is this dress a cocktail cress?” Neural network 1290 will ask: “Is this dress a casual dress?” If the image is found to be one of a cocktail dress, then the image is sent to identifier 1285 (which inputs it and its associated information into the image search at step 11 in FIG. 1). On the other hand, if the image is found to be one of a casual dress, then the image is sent to identifier 1295 (which inputs it and its associated information into the image search at step 11 in FIG. 1).

The advantage of modular neural network 1200 is that it speeds up image searching by providing a platform for training the image recognition search engine. Teaching the search engine's machine learning system to recognize objects on the basis of familiar product categories (e.g.: cars, clothes or furniture) makes system learning easier. Another advantage of the system is its modularity permitting different neural networks to be updated and trained separately. For example, neural network 1260 can be continuously trained and retrained to recognize when an object is a handbag. At the same time, another system administrator can be training network 1230 to recognize different types of furniture. Moreover, as new product categories develop, new neural networks can be added to the present system to cover these categories. In addition, several different neural networks can be created to handle images that were previously handled by only one neural network. For example, neural network 1230 for “furniture” could conceivably be replaced by three separate neural networks (not illustrated) looking for “beds”, “tables” and “chairs” specifically. As can be appreciated, the different neural networks that make up modular system 1200 can be changed over time. Different neural networks can be added, and other neural networks can be removed. An advantage of the present approach of a nested modular network composed of separate neural networks (feeding information from one to another) is that each of the individual networks are “wide” and “shallow” (as opposed to “deep” and “narrow”) in terms of the data they are processing. Again, this makes the training of the image recognition system fast and easy as compared to traditional approaches. Lastly, the images initially fed into the system at 1210 can be separate 2D picture images, or they may be images fed into the system at different times by feeding video stills into the system. When using video as the input, the present system can be trained to recognize which objects are present in the video at different periods of time. In accordance with the present invention, a movie of different people appearing in a video at different times can be fed into the present system such that it recognizes the clothing, objects, etc. appearing in the video at different times.

It is to be understood that the present system can display its image search results in many different formats and is not limited to simply displaying a 2D image on a user's computer screen. For example, the image search results can be displayed in one of 2D, 3D or virtual or augmented reality. For example, the search results can be displayed in 2D as seen on the user's computer screen, or in 3D on the user's computer screen (for example as rotatable images), or in virtual or augmented reality formats. For example, if the user is selecting a new dress, the user may see the dress in an augmented reality format (e.g.: floating in the air before them with their current room surroundings around them) when viewed through a virtual reality headset or display system. Alternatively, the user may see the dress in a virtual reality format (e.g.: walking down the street in New York's Time Square when viewed through a virtual reality headset or display system.

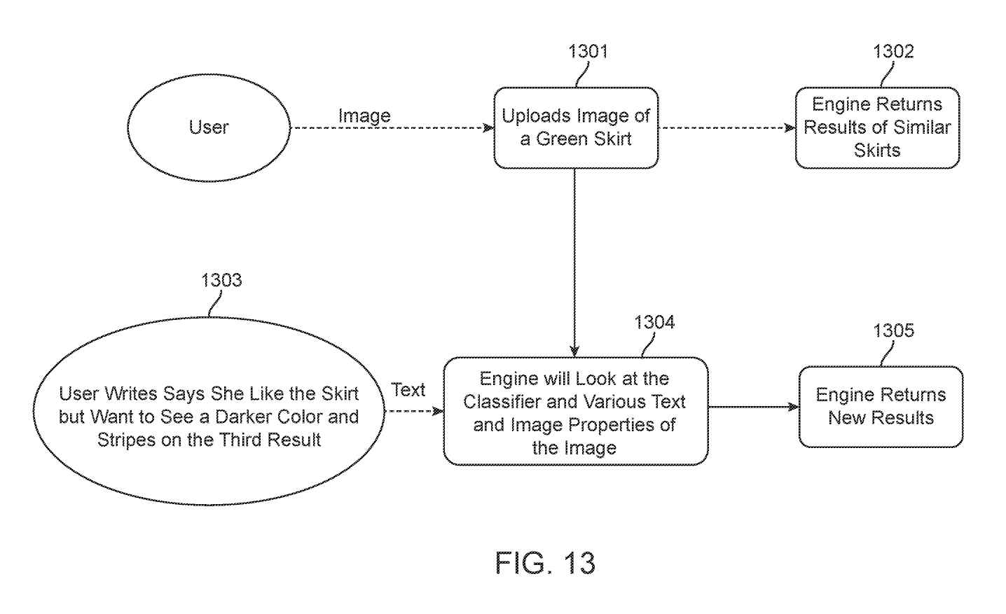

FIG. 13 is an illustration of a hybrid method 1300 for searching for images using both an image search engine and natural language processing, as follows. First, the user uploads an image at step 1301 (in this example it's an image of a green skirt). Next, at step 1302, the present system displays the image results on the user's computer. Next, at step 1303, the user sends a text, writing that she is looking for a design with a darker color and stripes. Next, at step 1304, the search engine will look at this text and use the text to further search for the optimal image (using the parameters as specified in the text). Finally, at step 1305, the computer will display the results of this hybrid image and natural language processing system.

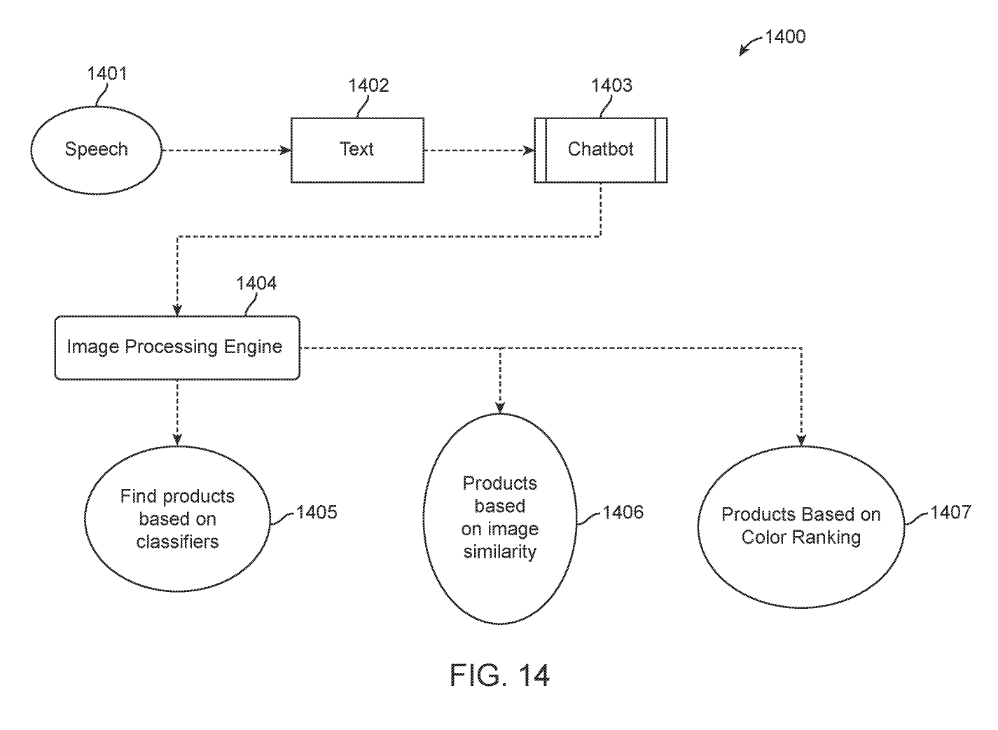

FIG. 14 is an illustration of a method 1400 of speech analysis to generate image search results, as follows. Similar to the example in FIG. 13 above, the user speaks at 1401 and enters text at 1402. The speech and text are processed by a chatbot at 1403 which in turn fees the voice and text information into an image processing engine 1404. Based on what the user says or asks for, the image processing engine and chatbot can together offer a variety of different image results. For example, if the user asks for a shirt with a particular type of collar, the system will classify the images based on collar type (i.e.: collar type is a “classifier”) and return the closest corresponding images at step 1405. If the user instead asks for a dress with “patterns like this”, the system will analyze the pattern in the image uploaded by the user and instead return the closest corresponding images to the uploaded pattern at step 1406. Finally, if the user instead asks for “more shirts of the same color”, then the computer system will return images of shirts with the corresponding color at step 1407.

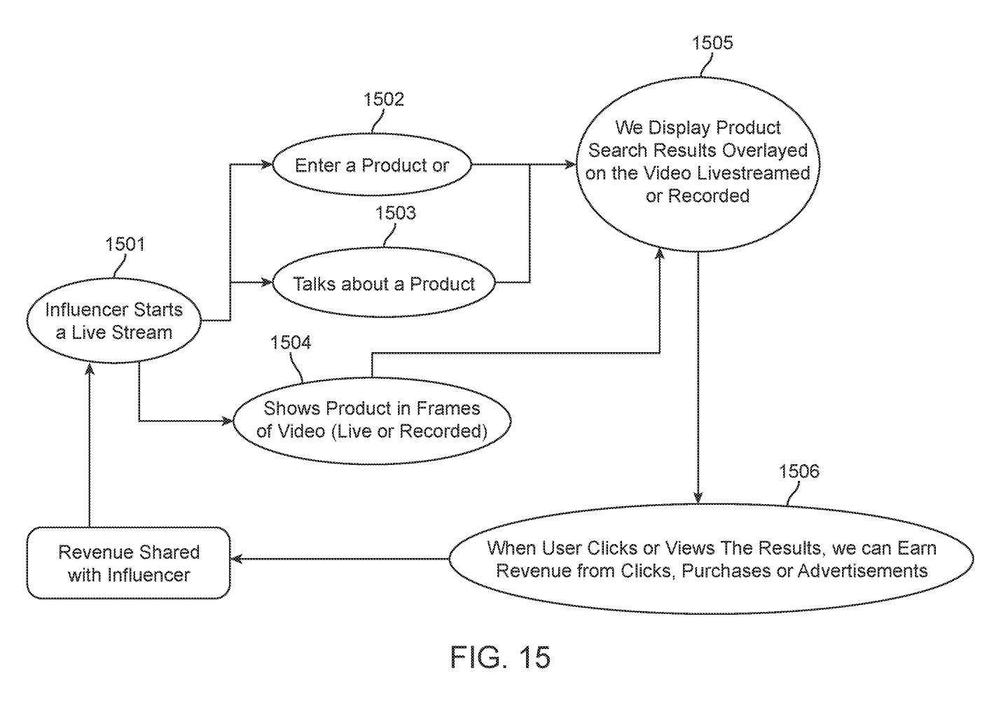

FIG. 15 is an illustration of a preferred method 1500 of performing image searches in conjunction with an influencer doing a video or livestream presentation. First, an influencer (e.g.: media personality, actor, etc.) will start a live stream video feed at step 1501. The influencer may enter details of the product into the system at 1502. Additionally, the influencer may speak about the product (and highlight its advantages and features) at step 1503. Additionally, the influencer may show the product visually to the camera (such that the product is displayed on the user's computer screen) at step 1504. Together, all of the data from 1502, 1503 and 1504 is fed into the present system's image processing engine at step 1505 such that the present system will search for images that best correspond to these inputs and display the resulting images on the user's computer screen. Ideally, the images displayed on the user's computer screen will be updated in real time and will correspond to the product that the influencer is promoting. At step 1506, the user can decide to purchase one of the items corresponding to the products the influencer is promoting—by selecting the corresponding image and link on their computer. Whenever a user makes such an online purchase, a small percentage of the revenue of the sale may be sent to the influencer at step 1507.

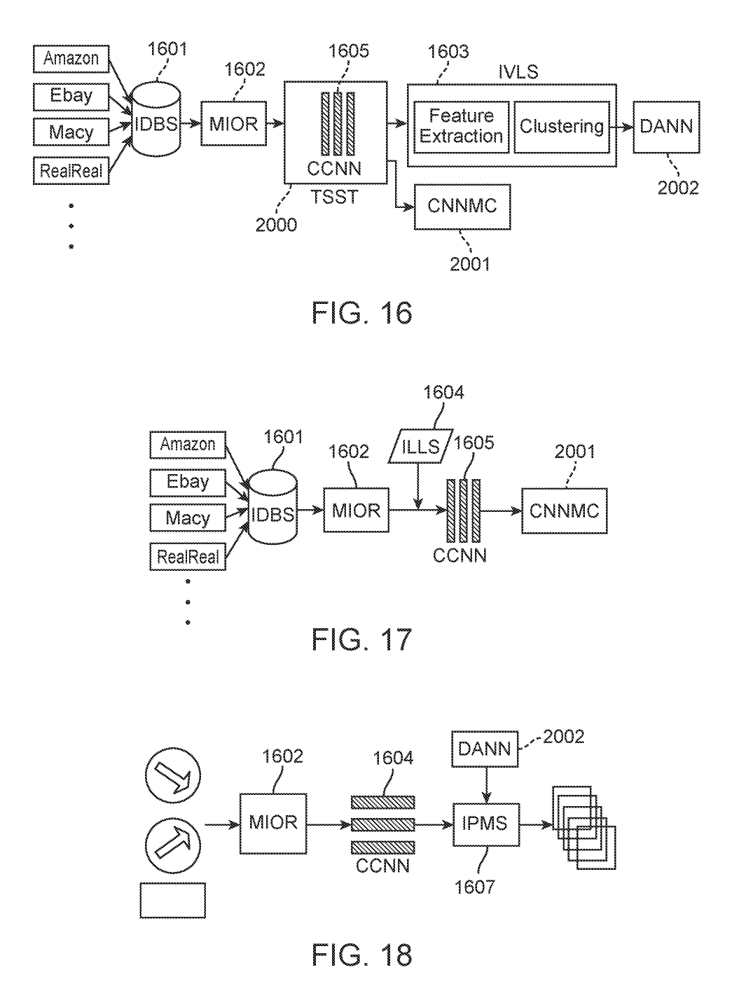

FIGS. 16 to 18 illustrate the training an operation of neural network that searches visual images, matches patterns and generates recommended images, as follows. FIG. 16 is an illustration of the training of an intelligent vision labelling system that comprises a neural network that uses machine learning. FIG. 17 is an illustration a similar system that uses natural language processing to train the system. Preferably, the present image recognition system is trained using both methods simultaneously—i.e.: machine learning and natural language processing.

As seen in FIGS. 16 and 17, visual images are extracted from different ecommerce and social media sites like Amazon, Macy's, eBay, RealReal, etc. These visual images are fed into the Intelligent Database System 1601 (labelled IDBS). These images are fed through a Multiple Intelligent Object Recognition system 1602 (labelled MIOR). In the machine learning approach of FIG. 16, the Triplet Semi-Supervised Training System 2000 (labelled TSST) trains the neural network (i.e.: the Connected Convolutional Neural Network CCNN) 1605 using triplets samples generated from images. In the natural language processing approach of FIG. 17, an Intelligent Language Labelling System 1604 (labelled ILLS) is used to automate data cleaning. The ILLS system 1604 can optionally be used as the foundation for a messaging bot that can talk to shoppers like a human assistant to further improve the online shopping experience. Once the training have been finished (by the TSST 2000 in FIG. 16 or the ILLS 1604 in FIG. 17), the graph models are fed into the Convolution Neural Network Model Compression 2001 (labelled CNNMC) which squeeze and optimize the neural network output model for future images prediction and searching applications platform including mobiles, embedded systems and Cloud Chatbots. In addition, in FIG. 16, an Intelligent Vision Labelling System 1603 (IVLS) is used to extract features from the images and cluster similar features together using pre-trained graph model. After that, the Dynamic Approximate Nearest Neighbors 2002 (labelled DANN) data structure transforms these clustered features into specific index structures dynamically for the following searching and querying.

FIG. 18 is an illustration of an intelligent pattern matching system that comprises a neural network CCNN 1604 and an Intelligent Pattern Matching System 1607 (labelled IPMS) which generates the images for display to the customer. Basically, the IPMS 1607 searches for images stored in the IDBS 1601 and presents images to the customer that are similar to the ones the customer is searching. An optional Multiple Intelligent Object Recognition system 1602 (labelled MIOR) enables the present system to recognize multiple objects in a frame at a time. The MIOR 1604 thus understands different objects in a given image or video. Optionally, different levels of neural networks can be used to extract features from an image of interest.

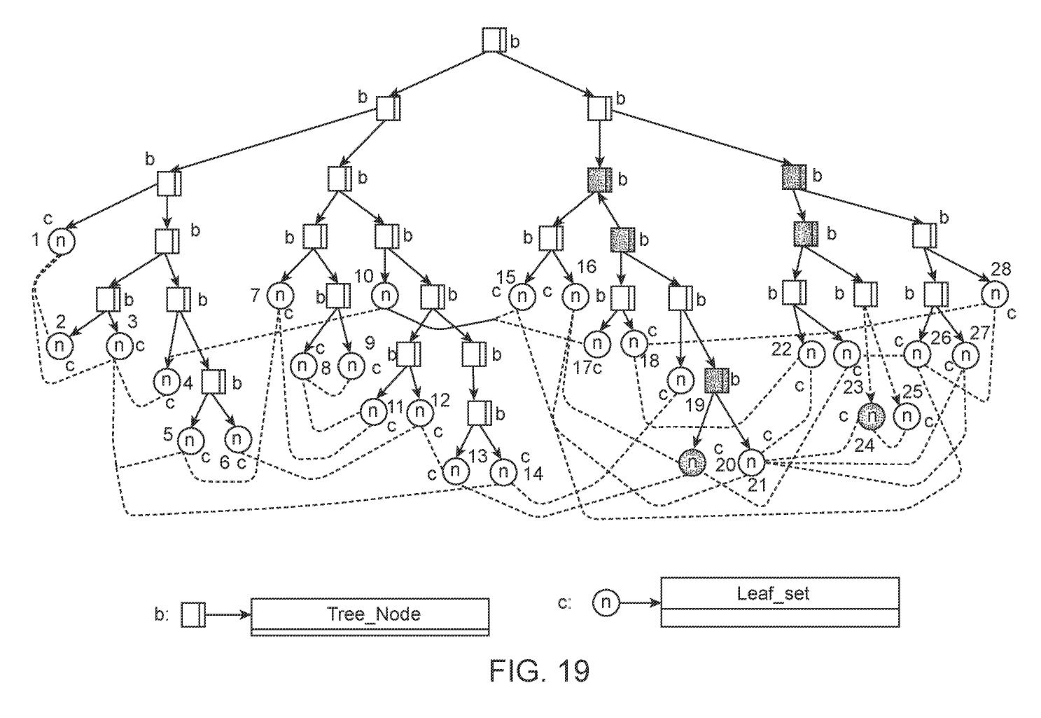

In FIGS. 16 and 18, after the feature extraction from training data or inference target, the link between features and database indexes is established for searching and matching. Considering the large amount of incoming training data, the present system uses a Dynamic Approximate Nearest Neighbors 2002 (labeled DANN) to construct the link table accurately and efficiently by constructing a new data graph structure. This new data structure graph is shown in FIG. 19. The structure is built as an undirected graph projecting an original dataset to low dimension subsets while keeping the connection between the original datasets. The advantages of this structure include that, firstly, it can dramatically add new data into the structure by adapting part of the graph without rebuilding the whole model. And, secondly, the loss of accuracy while updating is largely diminished because of the graph maintains the important relations within subsets.

Specifically, as seen in FIG. 19, each tree node contains a boundary parameter vector and a threshold parameter. This data structure compares the product of the feature vector and the boundary parameter with a threshold. Depending on the result, the processing is directed to the next consecutive tree or leaf node.

Preferably, each leaf contains: (1) features of the image subset, (2) an index of the leaf, (3) an index of the neighborhood, and (4) a center point vector. The neighborhoods are defined by whether the subset shares the boundary. The boundary is represented by the parameter stored in the tree nodes.

The process of updating graph of adding new data contains two parts: the up-down search and subgraph update. Firstly, the present system searches through the tree nodes to find the corresponding leaf node for the new point vector. Then, it calculates distances from input point to leaf center point as well as to the neighborhoods center points. If the new point is closer enough to the leaf center point than its neighborhoods, the system adds the image into this subset directly, otherwise, it will update the leaf and its neighbors by re-spitting the whole points in the subgraph.

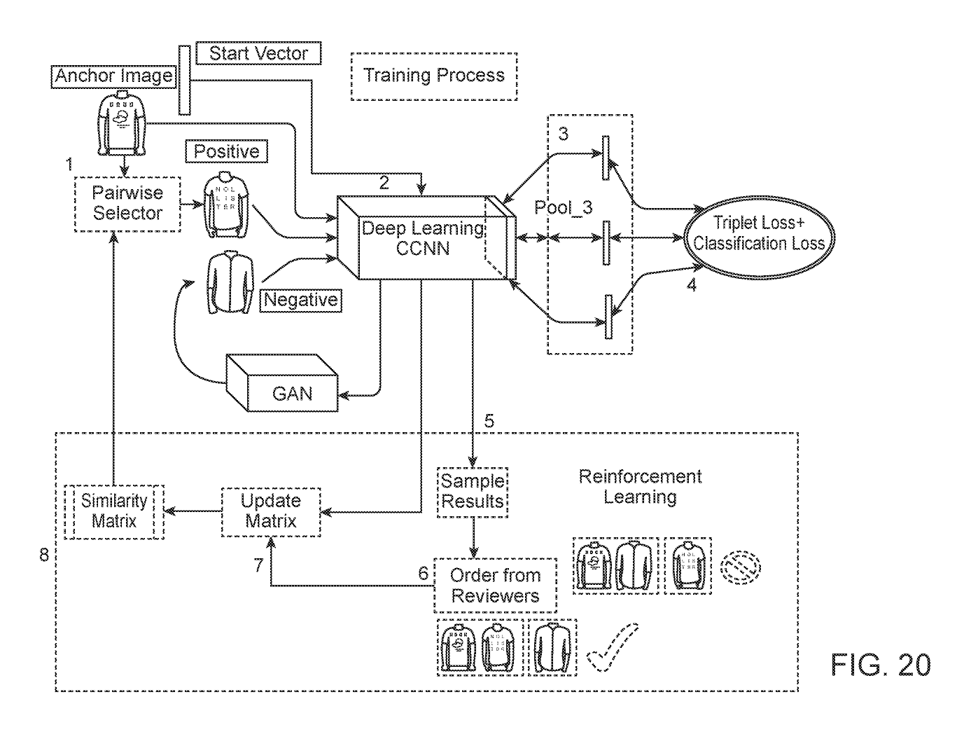

In FIG. 16, the Triplet Semi-Supervised Training System 2000 (labeled TSST) trains the neural network by implementing a semi-supervised process with triplet sample sets generated from input images and labels. The trained model is responsible for classification and feature extraction as seen in FIG. 20 in the following steps.

First, for each image within the training anchor set, one positive sample with the largest value in the similarity matrix towards the anchor image is selected. Then, the ‘negative’ sample is generate from random start vector using the Generative Adversarial Networks (labeled GAN) and Connected Convolutional Neural Network (labeled CCNN). Then, the triplet set are fed into the CCNN for training based on both triplet loss and classification(true-false) loss. For each epoch of training, the model can output the results of validated samples and use them for reinforcement learning process loop in which the model will get different rewards to update similarity matrix based on the reviewer feedback. The present system incorporates triplet Learning and GAN. The combination provides the model with strong ability to understand images and capture robust image features, considering the whole system share the CCNN model and focus on the same feature layer. This feature is refined by classification, generation and similarity selection. Thus, the present system could totally represent the characteristic and meaning of the image. Additionally, the GAN and reinforcement learning loop make the model training less sensitive towards the number of training data. Advantageously, the present system can therefore use small amount of training data to achieve good performance.

After the CCNN models are trained (in FIGS. 16 and 17), the present system uses the Convolution Neural Network Model Compression 2001 (labeled CNNMC) to compress the model for further implementation platform such as mobiles, embedded systems and Cloud Chatbot. Optionally, the full connected layer can be replaced with a local feature specified layer which makes the size of model five times smaller. Additionally, the present system can transform the feature vector into frequency domain and add one more feature dimension for feature pruning. With the sum of pruning parameter constrained, the present model can be transformed into a sparse model with less parameters and the same accuracy.

The preferred method replaces the fully connected layer prepared with Triplet Training is replaced with local feature-specified 2D convolutional layer. The size of 2D convolutional layer is decided by the area of objects in an image. The preferred method transforms the feature vector into frequency domain for compressing the neural network into a smaller size. Frequency domain is determined using standard Fourier Transform method. The frequency domain feature is pruned based on the importance of the feature which is generated from supervised training which is focused on the aspects of the images that are considered important.

What is claimed is:

1. A method for a user to select an article of merchandise online for 3D printing, comprising:
(a) the user uploading an image to a computer system in a search query;
(b) the computer system using image recognition software to find images similar to the uploaded image in the search query;
(c) the computer system displaying to the user the images that are similar to the uploaded image;
(d) the user selecting one of the displayed images, thereby selecting an article of merchandise corresponding thereto; and
(e) the user purchasing the article of merchandise for 3D printing by:
(i) downloading a 3D print model of the article of merchandise and then 3D printing the article of merchandise, or
(ii) purchasing the article of merchandise from a vendor that 3D prints the article of merchandise.

2. The method of claim 2, wherein the computer system displays a list of vendors, and the user selects the vendor.

3. The method of claim 1, wherein the display of images is presented to the user as a webpage, and wherein the webpage address is saved by the user as a unique URL.

4. The method of claim 1, wherein the images that are displayed to the user have been rated by the input of another user.

5. A method for a user to monetize image searches for an article of merchandise, comprising:
(a) the user uploading an image to a computer system in a search query;
(b) the computer system using image recognition software to find images similar to the uploaded image in the search query;
(c) the computer system displaying to the user the images that are similar to the uploaded image, wherein the display of images is presented to the user as a webpage having a unique URL;
(d) the user saving the unique URL;
(e) the user sharing the unique URL on social media;
(f) the user being paid when a second user:
(i) views the unique URL,
(ii) likes the unique URL,
(iii) shares the unique URL, or
(iv) purchases the article of merchandise through the unique URL.

6. The method of claim 5, wherein the user is paid by a business entity controlling the computer system.

7. The method of claim 5, wherein the amount paid to the user is calculated as a percentage of the purchase made by the second user to a seller of the article of merchandise in step (iv).

8. The method of claim 5, further comprising:
the user adding ratings to the displayed images on the webpage, and
the computer system incorporating the added ratings into the unique URL for the webpage, prior to the user saving the unique URL.

9. The method of claim 5, further comprising:
the user submitting video with product details overlayed thereon.

10. A method for a user to select merchandise online for purchase, comprising:
(a) the user uploading an image to a computer system in a search query;
(b) the computer system using image recognition software to find images similar to the uploaded image in the search query;
(c) the computer system displaying to the user the images that are similar to the uploaded image, wherein the display of images is presented to the user as a webpage, and wherein the webpage address is saved as a unique URL;
(d) the user selecting one of the displayed images, thereby selecting an article of merchandise corresponding thereto; and
(e) the user purchasing the article of merchandise.

11. The method of claim 10, wherein the computer system using image recognition software to find images similar to the uploaded image in the search query further comprises:
(i) the image recognition system generating keywords corresponding to the uploaded image; and
(ii) the image recognition system comparing the keywords corresponding to the uploaded image to keywords corresponding to other articles of merchandise stored in an index.

12. The method of claim 10, wherein the image uploaded by the user is an image from a video.

13. The method of claim 10, wherein the search results are based on preferences from other users in an affinity group that includes the user.

14. The method of claim 13, wherein the search results are sorted and prioritized when displayed to the user on the basis of the preferences of other members of the affinity group.

15. The method of claim 10, wherein the steps of:
(a) the user uploading an image to a computer system in a search query;
(b) the computer system using image recognition software to find images similar to the uploaded image in the search query; and
(c) the computer system displaying to the user the images that are similar to the uploaded image, are performed iteratively as follows:
(1) the user viewing the displayed images,
(2) the user selecting one of the displayed images as a preferred image,
(3) the computer system iteratively updating the search query using image recognition software to find images similar to the preferred image, and
(4) the computer system displaying to the user the images that are similar to the preferred image.

16. The method of claim 15, wherein the computer system displays the preferred image together with the images that are similar to the preferred image.

17. The method of claim 15, wherein the iteratively updated display of images is presented to the user as a webpage having a unique URL, and
(1) the user saves the unique URL, and
(2) the user shares the unique URL on social media.

18. The method of claim 15, further comprising:
(d) feeding a plurality of 2D images of an object into the image recognition system to generate a 3D image of the object and a 3D video of the object.

19. The method of claims 15, wherein the images displayed to the user on the computer screen are displayed as 2D, 3D, virtual reality or augmented reality images.

20. The method of claim 10, wherein the user is a product influencer, and the image is a video of a promoted product.

21. A method to build a modular neural network comprising a plurality of neural networks working together in which the neural networks are arranged into levels with images being passed from one level to another as objects are recognized and categorized.

22. The method of claim 21, further comprising:
dynamically constructing and updating a link between image data and search index, by:
(i) extracting features from images using a pre-trained CCNN model;
(ii) The search indexes represent the pointers id to target images;
(iii) building an undirected graph structure allowing updates in a sub-graph; and
(iv) maintaining the relationship of target image sets.

23. The method of claim 21, further comprising:
using a three-image set training system during the building of neural networks to extract robust image feature vector, by;
(i) selecting a three-image set that contains two image from training image set and one image from a Generative Adversarial Network, wherein the Generative Adversarial Network uses convolutional neural network to generate fake images from features extracted from the other two images;
(ii) comparing features from the three images with each other; and
(iii) optimizing a model by reinforcement learning rewards based on feedback from a reviewer.

24. The method of claim 21, further comprising:
compressing the size of neutral network models by using less parameters so that the model can be implemented in mobiles, embedded systems, wearable devices, in-memory applications and cloud applications, by:
(i) replacing the fully connected layer with a local feature specified layer; and
(ii) transforming a feature vector into a frequency domain for compression, wherein the frequency domain feature is supervised pruned based on the importance of the feature.
